(19) United States
(12) Patent Application Publication
(10) Pub. No.: US 2008/0044219 A1
(43) Pub. Date: Feb. 21, 2008

(54) STAIN AND ODOR DETECTION AND CLEANUP SYSTEM

(76) Inventor: William D. McKay SR., Grand Blanc, MI (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/923,618

(22) Filed: Oct. 24, 2007

Related U.S. Application Data
(63) Continuation of application No. 11/387,992, filed on Mar. 22, 2006.
(60) Provisional application No. 60/772,038, filed on Feb. 10, 2006.

(51) Int. Cl. A46B 11/00; F21V 33/00; B65D 5/66; B43K 29/00

(52) U.S. Cl. 401/123; 362/96; 222/113; 401/195

(57) ABSTRACT

A method and apparatus for detecting stains, urine, odor and feces, and more particularly, the combination of a black light detector and a liquid reservoir and/or trigger pump dispensing vehicle for containing stain removing chemicals is provided. The black light is selectively and removably mounted or positioned in the body of the dispensing vehicle.

This application claims priority of provisional application for 60/772,038 field Feb. 10, 2006.

This application is directed to a method and apparatus for detecting stains, urine, odor and feces, and more particularly, to the combination of a black light detector and a liquid reservoir and/or trigger pump dispensing vehicle for containing stain removing chemicals. The black light is selectively and removably mounted or positioned in the body of the dispensing vehicle.

### BACKGROUND OF THE INVENTION

Finding and cleaning up stains and other organic remains is a significant problem, especially in households where there are pets. Often times, a pet may leave urine or other bodily fluid stains on carpets, rugs and other floor surfaces, sometimes creating an unpleasant or even foul odor. In some cases, while it may be difficult to locate or even see where the stain is, the presence of a smell or odor in a room may well indicate that a stain in some location does indeed exist.

In the prior art, cleanup and removal of bodily fluid stains and other marks is typically accomplished by utilizing enzyme chemistry or other chemical materials that, stated simply, eat up the stains as well as provide a disinfectant and anti-odor treatment. Because of the difficulty in locating such stains, it would be desirable to provide a system which combines both a detecting mechanism, as well as a stain cleanup and removal component.

### SUMMARY OF THE INVENTION

The present invention relates to finding, detecting and cleaning up/removing old or new urine marks/stains or other organic matter such as feces, blood, saliva and more. Clean up and removal are accomplished by utilizing enzyme chemistry or other chemical (typically) materials that essentially eat up stains and odors and/or bleach or disinfectant.

In general, the invention combines a black light detector with a liquid reservoir and/or trigger or pump dispensing vehicle. Particularly, a black light is mounted within the body of the liquid reservoir or within the trigger or pump dispensing vehicle.

Particularly, the invention comprises the combination of a black light detector and a liquid reservoir and/or trigger or pump dispensing vehicle (the latter for retaining stain removing chemicals). The black light is normally mounted or positioned in the body of the dispensing vehicle. The black light is turned on in a darkened area (where a stain is believed to exist) so as to visually detect the stain, after which the liquid stain removing chemicals are applied to the stain.

The advantage of the inventive system is combining both the black light with the chemical dispensing unit into one unit—this provides one hand operation versus conventional two hand operation. A removable optional brush could be added to the system.

An additional embodiment uses a specially designed device/wand that is suitable for carrying the black light and a replaceable pump bottle containing liquid cleaner. Moreover, instead of the black light, the wand can carry a tape roll, sponge or cloth, or a foam or cushion bearing a delinting fiber surface. In other words, because the black light is removable, it can enable other items that are used in cleaning to be removably carried.

Thus, the system/method comprises turning the black light on in a darkened room and moving the dispenser across a surface where a stain may be located, identifying the stain, and then engaging the trigger of the dispensing vehicle to dispense cleaning and/or deodorizing chemicals, followed optionally by wiping the surface where the stain was located.

Accordingly, it is an object of the invention to provide an improved system for detecting stains.

Another object of the invention is to provide a stain detecting system which utilizes a black light detector.

A further object of the invention is to provide a stain detecting system in which a dispensing vehicle houses a light detector.

Still, other objects and advantages will be apparent from the following description.

### BRIEF DESCRIPTION OF THE DRAWINGS

FIG. 1 is a side elevational view of a dispensing vehicle of the invention containing a refillable bottle, a trigger sprayer and a selectively removable light unit;

FIG. 2 is a side elevational view similar to FIG. 1 and showing an optional brush hanging along the rear of the dispensing vehicle;

FIG. 3 is a front elevational view of the dispensing vehicle of FIG. 2;

FIG. 4 is an exploded side view of the dispensing vehicle of FIG. 2;

FIG. 4A is a top plan view of the light unit component of the dispensing vehicle of FIG. 4.

FIG. 5 is a partial side view showing the dispensing vehicle of FIG. 2 with an angled neck portion;

FIG. 6 is an exploded side view of a second embodiment of the inventive dispensing vehicle showing a sliding fit between a reservoir/bottle and a light unit;

FIG. 7 is a side view of the dispensing vehicle of FIG. 6 in an assembled condition;

FIG. 8 is a front elevational view of the dispensing vehicle of FIG. 6 in an assembled condition;

FIG. 9 is an exploded side view of a modified version of the inventive dispensing vehicle of FIG. 6 showing a snap fit between the reservoir/bottle and the light unit;

FIG. 10 is a side view of the dispensing vehicle of FIG. 9 in an assembled condition;

FIG. 11 is a front elevational view of the dispensing vehicle of FIG. 9 in an assembled condition;

FIG. 12 is a partial front view showing an alternative threaded mechanism for attaching the reservoir/bottle to the light unit;

FIG. 13 is a side elevational view of a third embodiment of the inventive dispensing vehicle in the form of a jug with a detachable trigger-sprayer;

FIG. 14 is a front elevational view of the dispensing vehicle of FIG. 13;

FIG. 15 is a side view of an optional trigger sprayer with built-in light unit for use with the dispensing vehicle of FIG. 13;

FIG. 16 is a front elevational view of a cap and light unit used for the embodiment of FIGS. 17A and 17B;

FIG. 17A is a side view of a fourth embodiment of the inventive dispensing vehicle comprising a bottle and a snap-on cap;

FIG. 17B is a front elevational view of the dispensing vehicle of FIG. 17A;

FIG. 18 is a side view of a fifth embodiment of the inventive dispensing vehicle including a wheel for facilitating movement across a floor;

FIG. 19 is a front elevational view of the dispensing vehicle shown in FIG. 18;

FIG. 20 is a front elevational view of a sixth embodiment of the inventive dispensing vehicle in the form of a wand;

FIG. 21 is a front elevational view of a revised wand as the dispensing vehicle and without the light unit or pump bottle clipped into the wand;

FIG. 22 is a side view of the wand of FIG. 21 and with the light unit and pump bottle attached;

FIG. 23 is a side elevational view of the upper portion of the wand shown in FIG. 21 and depicting a tape roll disposed in the wand upper compartment;

FIG. 24 is an exploded view of the wand portion shown in FIG. 23 and depicting the wand upper compartment, a tape roll receptacle, and the tape roll;

FIG. 25 is a side elevational view of an absorbent member disposed in the upper compartment of the wand of FIG. 21;

FIG. 26 is a side view of a cushion material with a delinting fiber surface being disposed in the upper compartment of the wand of FIG. 21;

FIG. 27 is a side view of an alternative version of the wand depicted in FIG. 21 with a tape roll unit threadingly connected to the wand lower compartment; and

FIG. 28 is an exploded view of the tape roll unit shown in FIG. 27.

### DETAILED DESCRIPTION OF THE INVENTION

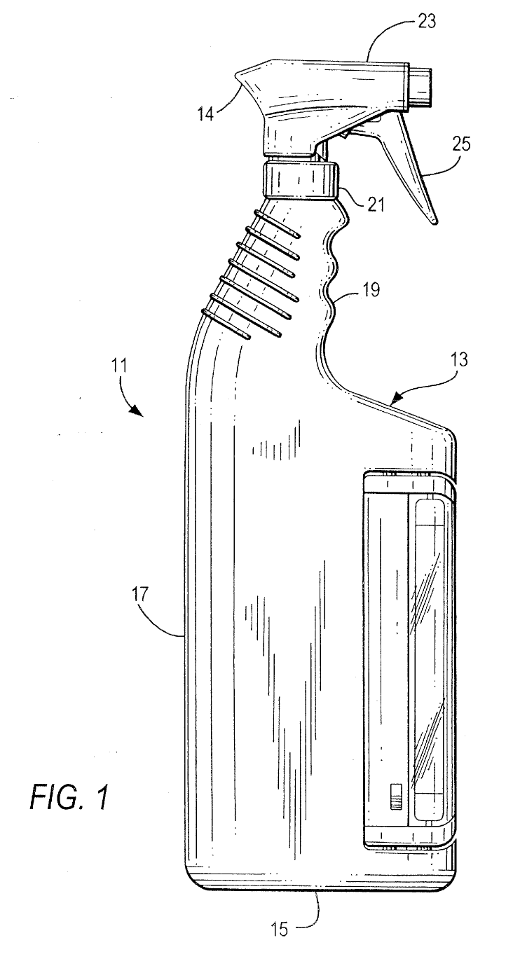

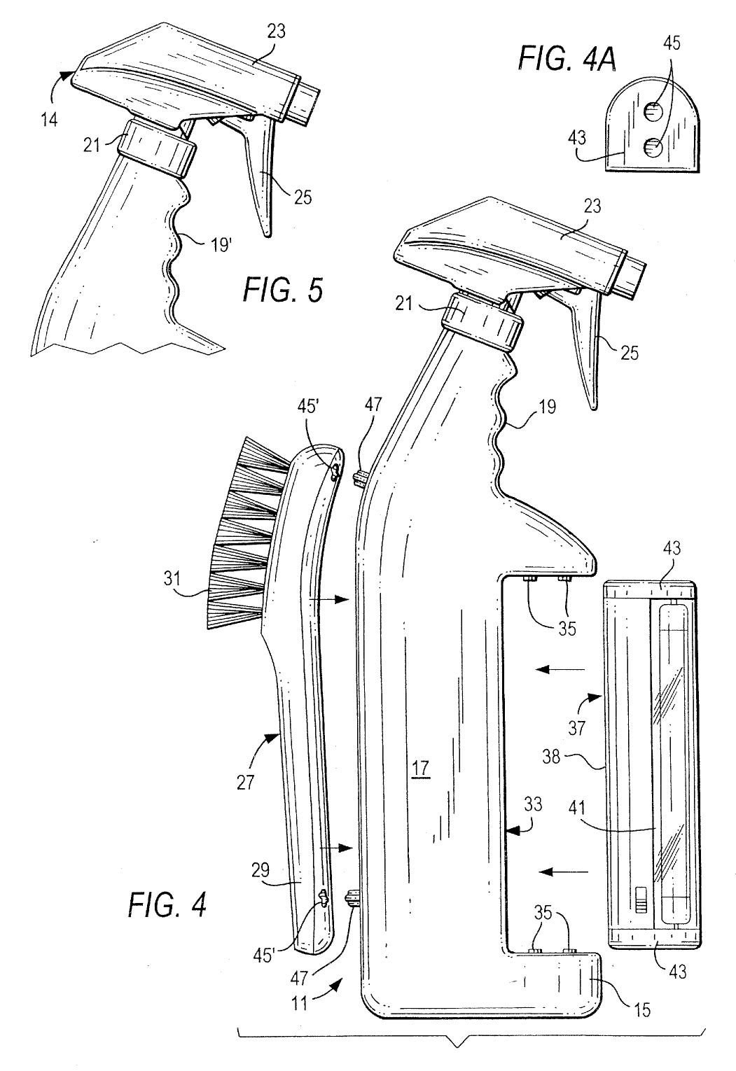

Referring first to FIGS. 1-4, a first embodiment of the dispensing vehicle, generally indicated at 11, and made in accordance with the invention, is now described. Dispensing vehicle 11 comprises a bottle 13, a trigger sprayer unit 14 and a selectively detachable light unit 37. Bottle 13 is defined by a base 15, a body 17 and a neck 19. Body 17 of bottle 13 is formed with a longitudinally extending forward cavity 33 (see FIG. 4) for selectively receiving light unit 37. Bottle 13, which can be made of polyethylene, PVC or PETE, contains a reservoir (not shown) for housing liquid treatment chemicals, such as cleaning-type chemicals that are suitable for application to and treatment of organic stains produced from urine, feces, blood, saliva, etc.

Removably mounted along neck 19 of bottle 13 is a trigger sprayer unit 14 for enabling selective dispensing of the liquid treatment chemicals housed in the reservoir of bottle 13, as is well-known in the art. Trigger sprayer unit 14 includes a mounting cap 21 removably coupled to neck 19, a spray element 23 seated within cap 21, and a trigger 25.

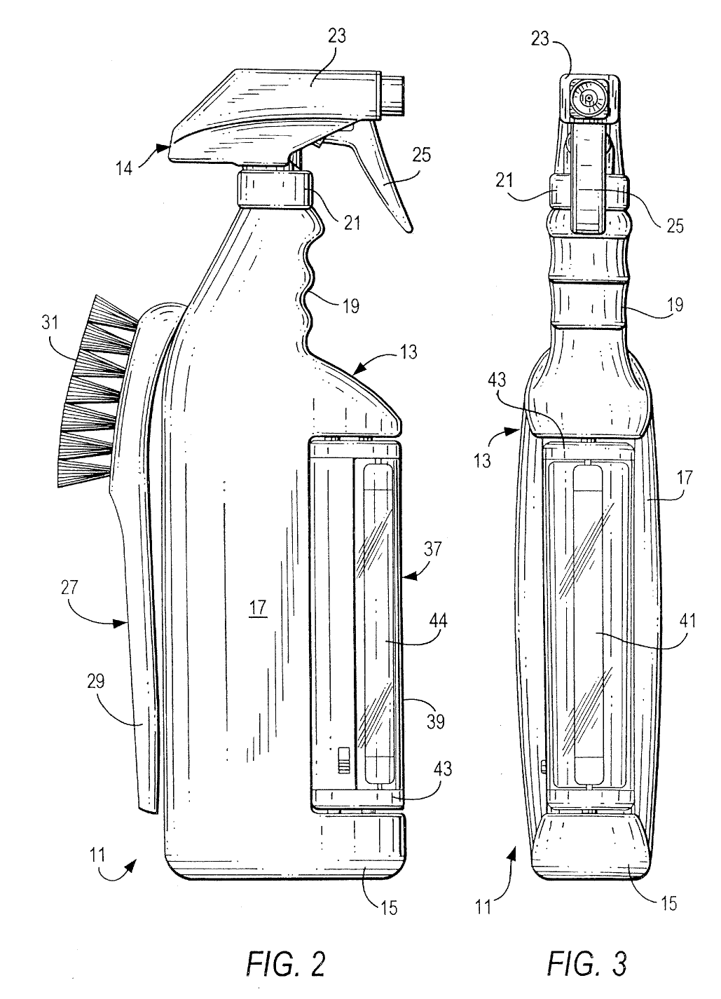

Light unit 37, as shown best in FIGS. 2 and 4, is defined by a longitudinally extending receptacle 39 that is sized to be selectively received in cavity 33 of bottle 13. In particular, receptacle 39 has ends 43 that are formed with a pair of indents 45 (see FIG. 4A) which are designed to selectively engage and catch a corresponding pair of protrusions 35 that depend from the upper and lower segments of cavity 33. (See FIG. 4). This enables light unit 37 to be selectively and slidably mounted within cavity 33 (see FIGS. 2 and 3).

As shown in FIGS. 2-4, light unit 37 carries a longitudinally extending black light 41 of a type well-known in the art. Black light is used to detect stains in a darkened location. Therefore, in accordance with the invention, black light 41 of light unit 37 is incorporated within dispensing vehicle 11 so that vehicle 11 functions both as a stain detecting system and a stain treatment/cleanup system. Cleanup and treatment of the stain is achieved by selectively spraying liquid treatment chemicals that are stored in the reservoir of bottle 13 of vehicle 11, as described herein.

Optionally, as best shown in FIG. 5, bottle 13 of dispensing vehicle 11 may have a neck 191 that is formed at a forward angle so that sprayer unit 14 points more directly down onto where a stain needs to be treated and without requiring significant movement of bottle 13.

Dispensing vehicle 11, as shown in FIGS. 1-4, may also include a brush 27 that is carried along the rear of bottle 14. Brush 27 includes a handle 29 and a bristle member 31 defined by a plurality of bristles. As shown in FIG. 4, handle 27, for purposes of selective storage along the rear of bottle 13, is formed with a pair of cutouts 45 which can selectively engage a corresponding pair of pegs 47, depending rearwardly from the back portion of bottle 13.

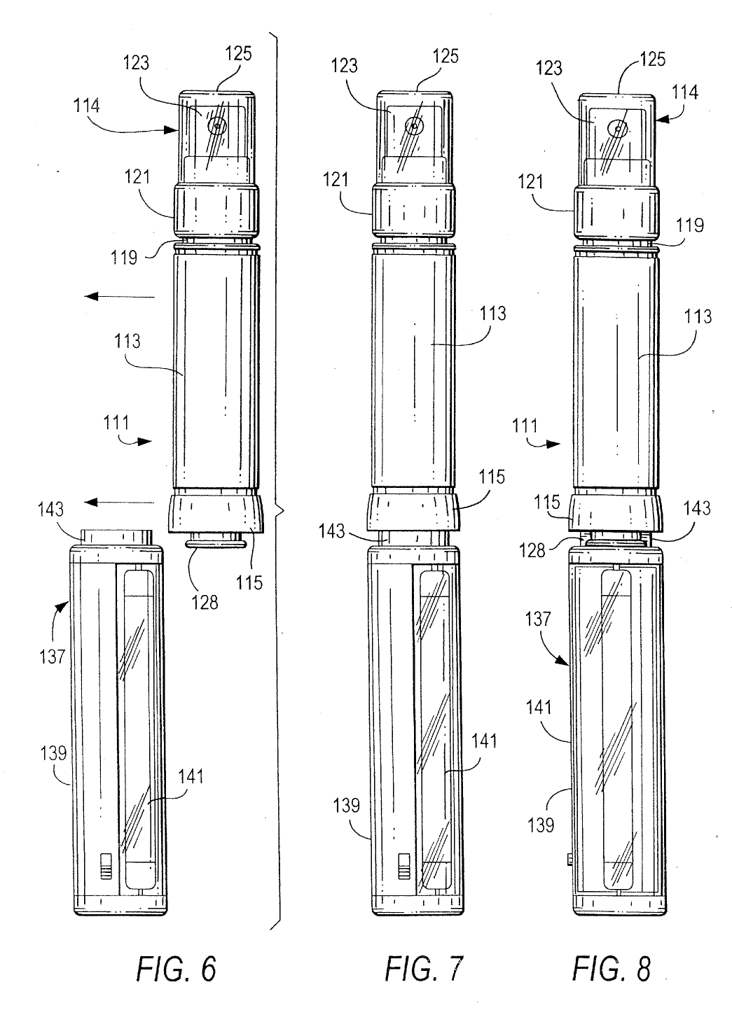

Turning now to FIGS. 6-12, a second embodiment of the inventive dispensing vehicle is shown generally indicated at 111. Dispending vehicle 111 includes a bottle 113, a pump sprayer unit 114 mounted on bottle 113, and a selectively detachable light unit 137. In this embodiment, bottle 113 has a neck 119 on which a pumper sprayer unit 114 is rotatably mounted. Pump sprayer unit 114 includes a pump 123 that may be downwardly pressed to selectively spray liquid stain removing treatment chemicals stored in bottle 113, a cap member 121 which rotatably engages neck 119, and a clear cover element 125 removably disposed over pump 123.

Referring now specifically to FIGS. 6-8, bottle 113 also includes a lower base element 115 having a depending slide member 128 that is designed to slidably and selectively engage a slot element 143 of light unit 137 (see FIG. 6). As before, light unit 137 includes a receptacle 139 and a longitudinally extending black light 141 housed in receptacle 139. Along the top of receptacle 139, slot element 143 is provided, and is sized for selective slidable engagement with, slide member 128 of base element 115. As a result, light unit 137 is selectively attachable to and removable from bottle 113 of dispensing vehicle 111.

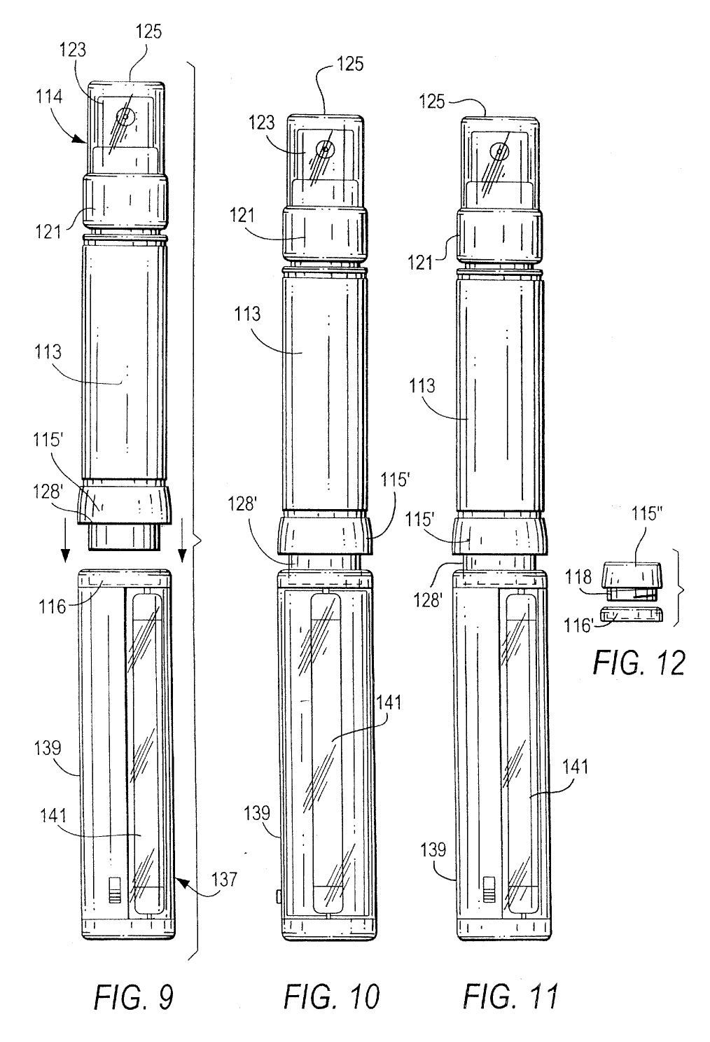

In an alternative version to the embodiment shown in FIGS. 6-8, dispensing vehicle 111 will have light unit 137 designed to be selectively engaged to bottle 113 by means of a friction fit, as best shown in FIGS. 9-11. In particular, bottle 113 will be formed with a base element 1151, having a depending bore element that is sized to frictionally fit within an opening 116 formed in the upper end of receptacle 139 of light unit 137 (see FIG. 9).

Turning now to FIG. 12, a further mechanism is shown for selectively coupling bottle 113 and light unit 137 of dispensing vehicle 111 depicted in FIGS. 9-11. In this version, base element 115^{II} is formed with a depending threaded member 118 that is designed to be threadingly received within opening 116^{I} formed in the upper end of receptacle 139 of light unit 137.

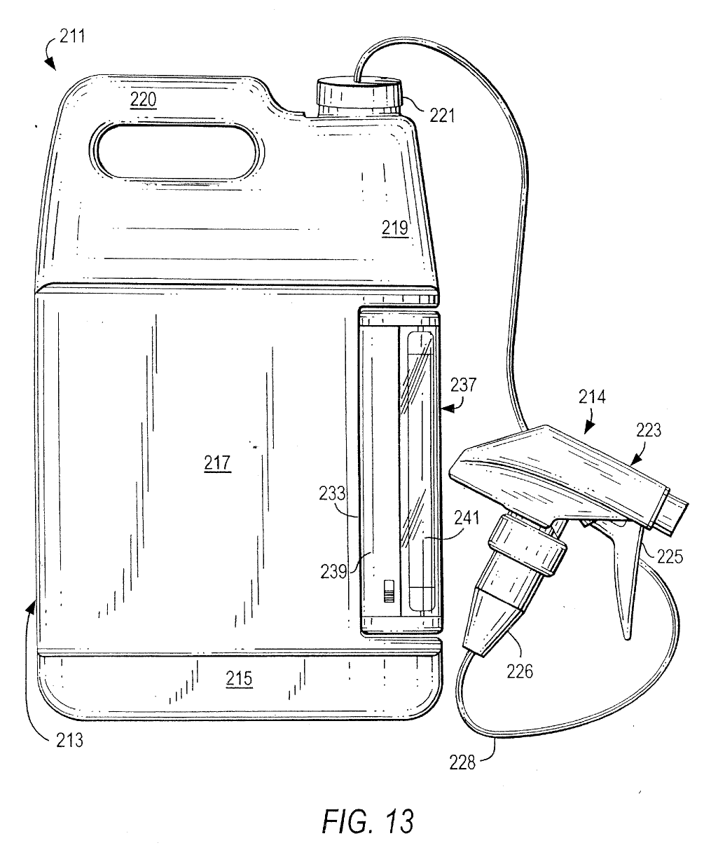

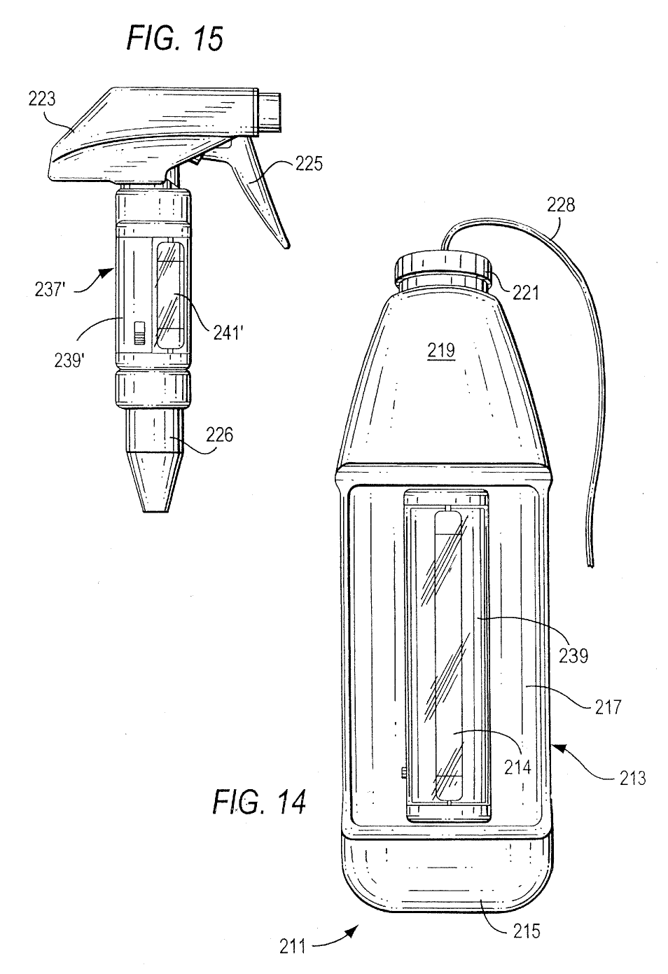

Turning now to FIGS. 13-15, a third embodiment of the inventive dispensing vehicle is generally shown at 211. Dispensing vehicle 211 includes a jug 213, a removable trigger sprayer unit 214, and a light unit 237. Jug 213 is defined by a base 215, a body 217 and a neck portion 219. A handle element 220 is shown formed within neck portion 219. As before, jug 213 includes a reservoir (not shown) which stores liquid stain treatment chemicals that are suitable for application to a stain to be treated and/or removed.

Trigger sprayer unit 214 is formed with a sprayer element 223, a trigger 225 and a neck 226 that is designed to be selectively seated along a cap element 221 mounted on neck portion 219 of jug 213. Extending from neck 226 of trigger spray unit 214 is a tubing 228, which runs from the inside of the reservoir of jug 213. This provides a vehicle for selectively transporting liquid stain treatment chemicals housed in the reservoir of jug 213 to trigger sprayer unit 214 so that the liquid stain treatment chemicals may be selectively sprayed onto a stain to be treated.

As with the embodiment of FIGS. 1-4, jug unit 213 is formed with an extending cavity 233 along the front portion of body 217 for selectively receiving light unit 137. Light unit 137, similar to what is shown in the first two embodiments of the inventive dispensing vehicle described herein, includes a receptacle 239 and a longitudinally extending black light 241 mounted in receptacle 239.

As shown in FIG. 15, trigger sprayer unit 214 is shown having been modified to include a light unit 237^{I} removably disposed between sprayer element 223 and neck 226. Once again, light unit 237^{I} includes a receptacle 239^{I} and a black light 241^{I}.

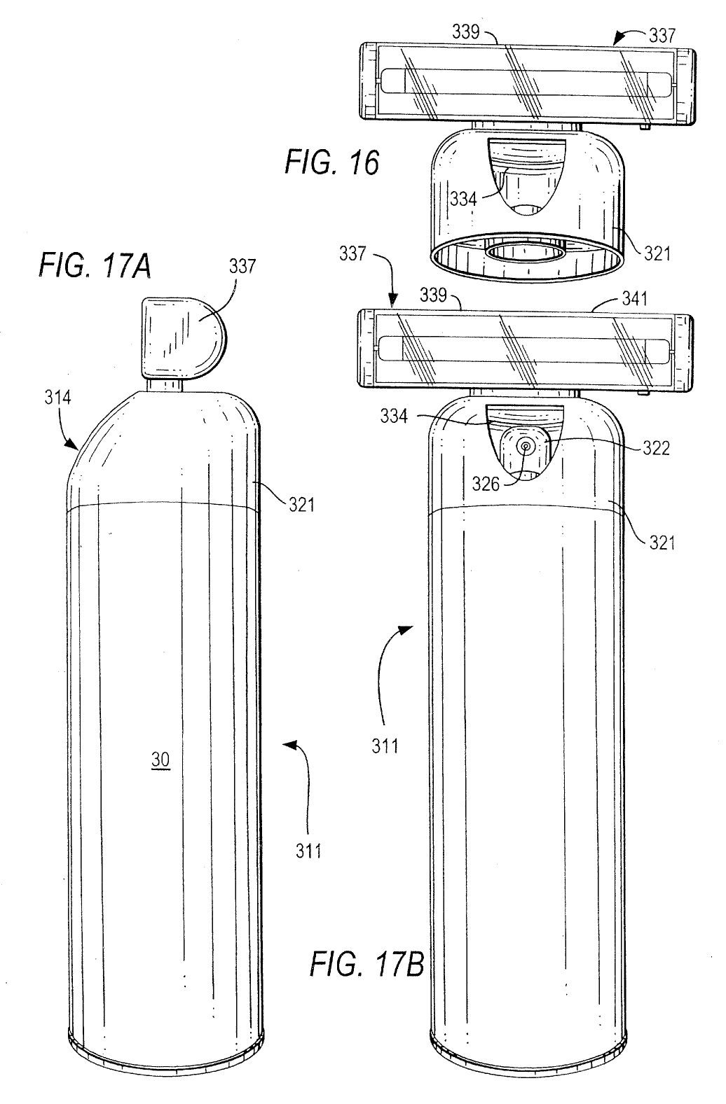

Referring now to FIGS. 16, 17A and 17B, another embodiment of the inventive dispensing vehicle is generally shown at 311. Dispensing vehicle 311 includes a bottle 313, a pump spray unit 314 and a light unit 337. Bottle 313 contains liquid stain treatment chemicals for treating a stain which can be selectively dispensed by means of pump spray unit 314. Pump spray unit includes a dispensing valve member 322 and a snap-on cap 321 formed with an opening 334 so that valve element 322 is accessible.

Light unit 337 is integrally formed as part of cap 321 and is seated horizontally on top thereof. As before, light unit 337 includes a receptacle 339 for housing a black light 341. Operation of dispensing vehicle 211 requires pressing down on light unit 337, which urges a select amount of liquid stain treatment chemicals to be dispensed out through a dispensing opening 326 formed in valve element 322.

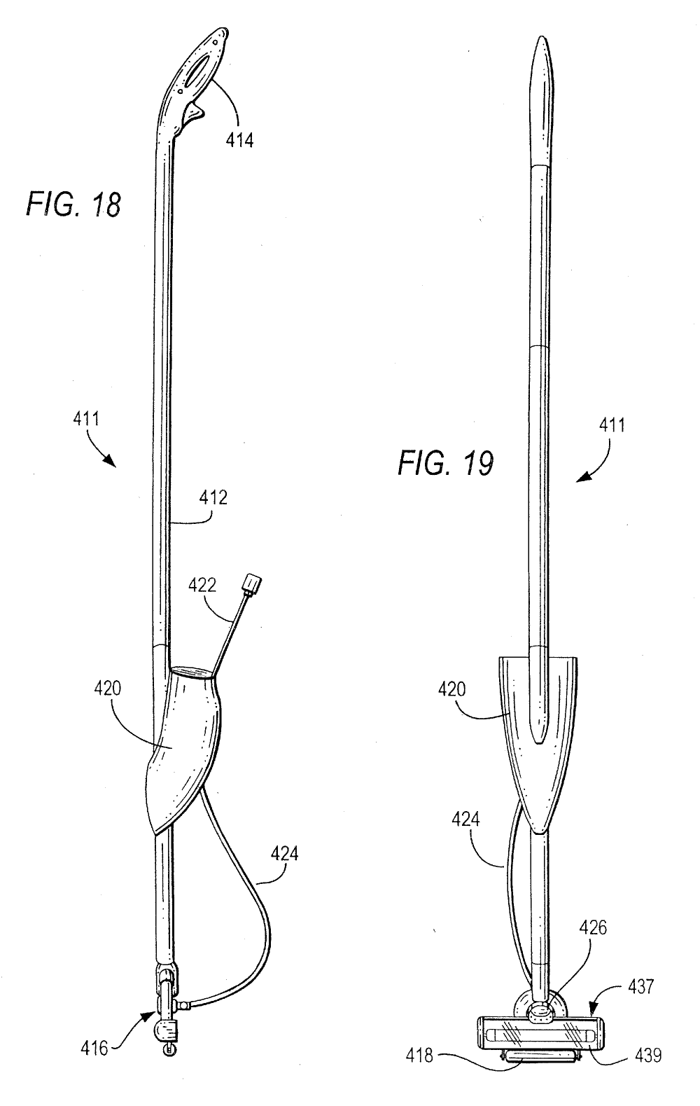

In FIGS. 18 and 19, a fifth embodiment of the dispensing vehicle of the invention is shown at 411. Dispensing vehicle 411 is suitable for being wheeled along a floor or carpet area and is defined by an elongated rod 412 with an upper grip portion 414 and a lower dispensing head generally indicated 416. Dispensing head 416 includes a lower wheel 418 to facilitate movement along a floor, above which a light unit 437 (similar to that described previously) is horizontally mounted. Light unit 437, as before, is defined by a receptacle 439 for housing a black light 441.

Disposed along rod 411 and intermediate grip portion 414 and dispensing head 416 is a receptacle 420 for housing a bottle (not shown) that stores liquid stain treatment chemicals suitable for treating a stain on the floor. A valve cap 422 is provided and is in communication with the bottle housed in receptacle 420. Valve cap 422 is designed to be selectively displaced in order to release the stain treatment chemicals through a tubing 424 and out a dispensing opening 426 formed in lower dispensing head 416 and located just above light unit 437.

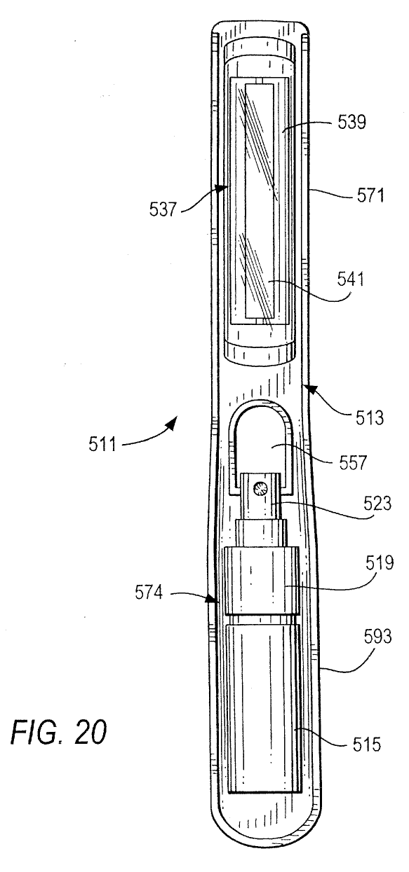

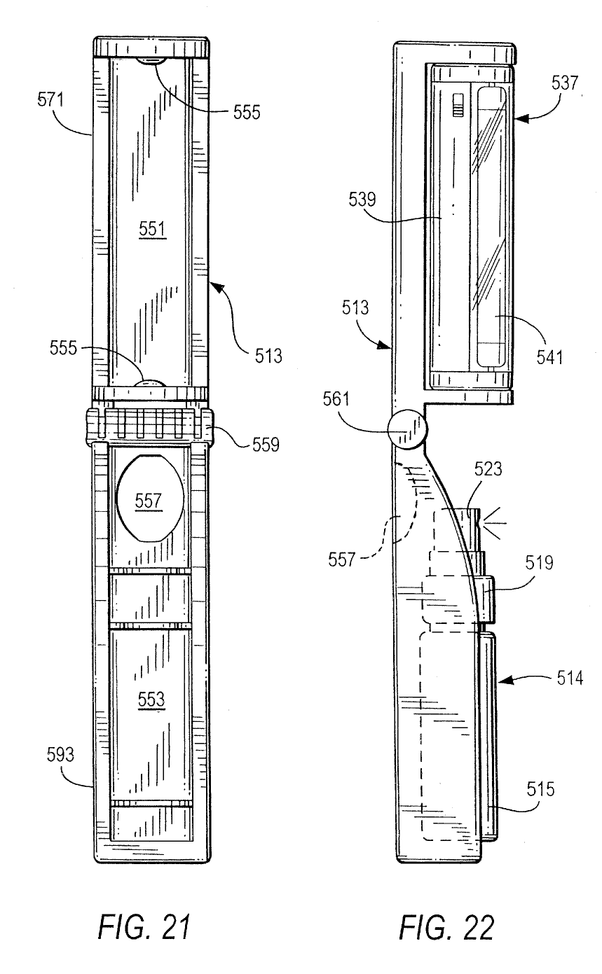

Turning now to FIGS. 20-22, a sixth embodiment of the inventive dispensing vehicle is generally illustrated at 511. Dispensing vehicle 511 is in the form of a wand 513, which can be made of polyethylene, polypropylene, styrene, ABS or PVC. Wand 511 has an upper segment 591 defining an upper compartment 551 for selectively receiving a light unit 537 and a lower segment 593 defining lower compartment 553 for selectively receiving a pump spray bottle unit 514. As before, light unit 537 includes a receptacle 539 and a black light element 541 mounted in receptacle 539. Upper compartment 551 is formed with upper and lower nibs 555 (see FIG. 21) for enabling light unit 537 to be removably mounted in upper compartment 551 by means of a friction fit.

Pump spray bottle unit 514 includes a body 515, a neck 519 and a pump element 523, as is well known. Spray bottle unit 514 is removably mounted in lower compartment 553 of wand 513 by means of friction fit. Lower segment 553 of wand 513 is formed with an opening 557 to facilitate insertion of a user's finger through wand 513 in order to enable selective activation of pump element 523 of pump spray bottle unit 514.

As shown in FIG. 21, upper and lower segments 591 and 593 of wand 513 may be connected to one another by, for example, a tongue and groove arrangement 559. As a result, segments 591 and 593 of wand 513 may be folded together in order to reduce the space required for storage of dispensing vehicle 511.

Alternatively, as shown in FIG. 22, instead of a tongue and groove mechanism, upper and lower segments 591 and 593 of wand 513 may be pivotally connected to one another by means of a hinge 561, again to enable wand 513 to be stored in a folded condition.

As an option, instead of mounting light unit 537 in upper compartment 551, upper pocket 551 may receive an optional cleaning element insert, such as a directional lint removal cloth, a sponge, a foam insert or some other cloth or cloth-type insert suitable for the treatment of surfaces.

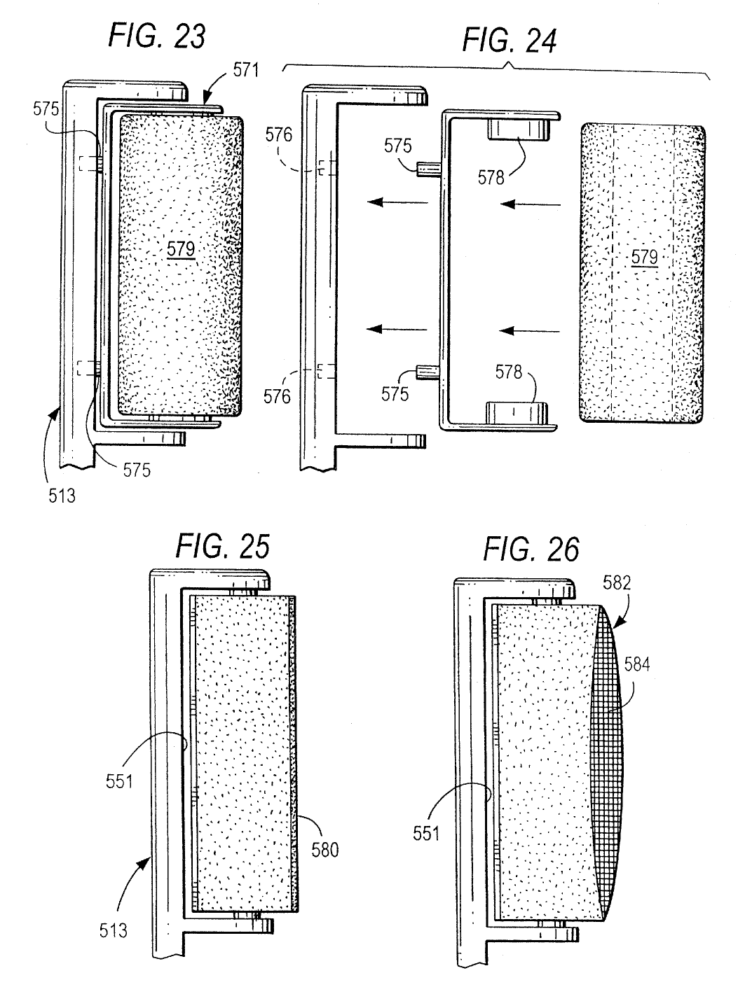

In this regard, reference is made to FIGS. 23 and 24, in which a cleaning unit 571 is disposed in upper compartment 551, defined by segment 591 of wand 513. Cleaning unit 571 comprises a receptacle 573 which selectively snaps into compartment 551. This is achieved by receptacle 573 having rearwardly extending prongs 575 which are sized to be selectively received within slots 576 formed in upper segment 591. Receptacle 573 of cleaning unit 571 includes a pair of inwardly directed hubs 578 on which a tape roll 579 is rotatably mounted. Tape roll 579 may comprise ______.

In FIG. 25, an absorbent foam or sponge member 580 is shown selectively disposed in upper compartment 551 of wand 513. Instead of being a foam or sponge, member 580 can be made of an absorbent non-woven or cloth material.

In FIG. 26, a foam or cushion material 582 is shown selectively disposed in upper compartment 551 of wand 513. Foam or cushion material 582 may be of any shape, but should preferably be oblate with a portion of the foam's surface covered with an adhesively affixed “de-lint” directional fiber material 584 running in a horizontal direction. Preferably, any remaining portion of the foam's surface should be covered with the same directional de-lint fiber surface material and positioned horizontally, but it an oppositely disposed direction.

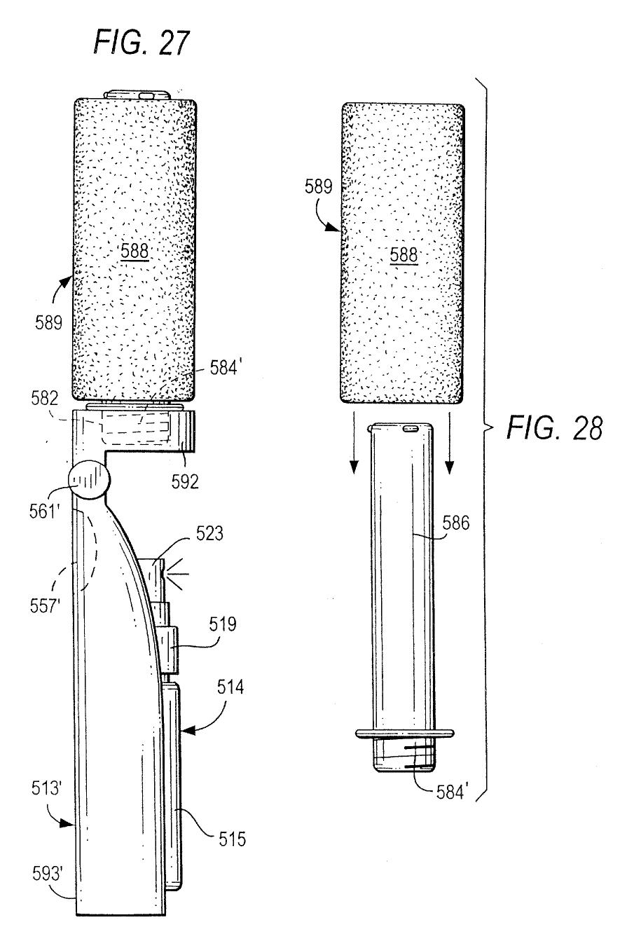

FIG. 27 shows a modified version of a wand in accordance with the invention and generally indicated at 513^{I}. Wand 513^{I} is defined by only a first lower segment 593^{I} having an elongated receptacle (not shown) designed for selectively receiving bottle 514 by means of a friction fit. As before, segment 593^{I} of wand 513^{I} is formed with an access opening 557^{I}. An upper support 592 is shown pivotally attached to segment 593^{I} by means of a rotating hinge 561^{I}. Support 592 is designed to receive and support a tape roll 589.

Tape roll 589 (see FIG. 28) comprises a tape roll member 588 and a core element 586 to which tape roll element 588 is rotatably mounted. Core element 586 has a threaded portion 584 formed at one end thereof and designed for threading engagement in a bore 582 formed within upper support 592 of wand 513^{I} and thus tape roll 589 is capable of being detachably coupled to one end of wand 513^{I}.

In accordance with practicing the invention, the room in which it is believed that a stain is present is first darkened. Then, the black light is activated. The inventive dispensing vehicle with an integral black light is moved across the surface where a stain is suspected to be located in the room (carpets, rugs, pet beds, hard surfaces, clothes, undergarments, bedding, etc.) in order to search for the stain. Once the stain is found, a trigger or pump of the dispensing vehicle is engaged in order to dispense cleaning-type chemicals onto the stain, after which the surface is wiped using a sponge, brush or absorbent non-woven cloth.

The integral combination of a black light with the body of a liquid reservoir, or with the body of a trigger sprayer or pump sprayer, of a dispensing vehicle is advantageous, as described below. Black lights are, admittedly, commonly used for detecting stains.

The dispensing vehicle of the invention must include a liquid storage reservoir and black light integrally and removably positioned in a compartment of the vehicle or attached to the side of the reservoir of the vehicle. Alternatively, the black light is integrally and removably positioned in a compartment of the trigger or pump dispenser of the vehicle, or is attached to the side of the trigger or pump.

The inventive system is far more convenient than prior systems. Prior art methods involve grasping the black light in one hand and the bottle/dispenser in the other. Thus, the process or searching for a contaminant, identifying it and then spraying a chemical or pouring chemicals onto the contaminant becomes a two-hand operation. The inventive system is advantageously operable with only one hand.

The reservoir (for containing the liquid cleaning chemicals) of the inventive dispensing vehicle is preferably manufactured of PVC, polyethylene or polypropylene. The plastic pump or trigger dispenser preferably is made of polypropylene.

The black light itself is well known in the art. A black light is basically a fluorescent lamp with a different type of phosphorous coating. This coating absorbs harmful shortwave light and emits UV-A light. Black lights come in both bulb and tube form. The emitted UV light reacts with external phosphors. The external phosphors glow when the UV light shines on them.

In accordance with the invention, a trigger or pump of the dispensing vehicle can be eliminated and a standard cap closure may be used in order to selectively pour liquid/cleaner onto a stain.

The inventive dispensing vehicle, as previously described, may be a specially designed wand device for carrying a black light and a separate pump unit containing liquid cleaning chemicals. Instead of the black light, the wand could carry, in the light's place, a tape roll, sponge or cloth, or a foam cushion bearing a delinting fiber surface.

An optional brush to agitate the cleaner could be included. Such a brush can be snapped onto the dispensing vehicle for storage purposes.

It is noted that the black light is most effective in identifying stains within 12 inches of the light.

Today, black lights are sold separately from cleaner compositions, or else are included in the box with a cleaner composition. There has been no teaching of a black light which can be stored on or within a dispensing vehicle and selectively removable therefrom.

The inventive system is advantageous since there is no need to individually find and/or purchase a black light and cleaning chemicals. The system includes both in one unit.

Also, because two-handed systems are harder to use, it is difficult to find and eliminate stains when operating in accordance with the prior art.

In accordance with the invention, an antimicrobial composition, a disinfectant, bleach and/or enzyme chemicals may be used as the cleaning chemicals. Moreover, a traditional fluorescent bulb can be added and placed adjacent to the black light in order to assist the user in navigating around a darkened room prior to the activation of the black light.

Also, in accordance with the invention, the black light detector could be integrally built into the dispensing vehicle without being removable.

Moreover, although a black light detector is, by far, the preferred light detector to be used in the inventive system, other lights suitable for detecting stains or organic matter could be used such as, for example, UV LEDs (as a source for UV light)—reference is made to U.S. Pat. No. 6,727,738.

The scope of the invention will now be set forth in the following claims.

1. A system for detecting and eliminating stains comprising:
a bottle for housing liquid in a reservoir containing stain removing chemicals and having a top end and a bottom end;
a dispensing mechanism coupled to the top end of said bottle and in communication with said reservoir for selectively dispensing at least a portion of said liquid onto a surface; and
a light unit containing a light element suitable for detecting a stain on said surface.

2-5. (canceled)

6. The system of claim 1, wherein said bottle includes a neck region to which said dispensing mechanism is coupled.

7. The system of claim 6, wherein said dispensing mechanism is detachably coupled to said neck region.

8-9. (canceled)

10. The system of claim 1, wherein said dispensing mechanism includes a pump sprayer.

11-16. (canceled)

17. The system of claim 1, wherein said light unit is detachably coupled to said bottom end of said bottle by means of an engagement mechanism selected from the group consisting of a slide fit, a friction fit and a screw fit.

18-32. (canceled)

33. The system of claim 1, wherein said light element is a black light element.

34. The system of claim 1, wherein said pump sprayer includes a pump and a cap element engaging said one end of said bottle

35. The system of claim 17, wherein said engagement mechanism 15 defined by a member depending from said bottom end of said bottle and an opening formed in one end of the light unit for receiving said member.

36. The system of claim 35, wherein said depending member is frictionally received in said opening.

37. The system of claim 35, wherein said depending member is an element threadingly received in said opening.

38. The system of claim 1, wherein said bottle and said light units each have a tubular configuration and are co-extensive with one another when coupled together.
